(19) United States
(12) Patent Application Publication
(10) Pub. No.: US 2011/0060676 A1
(43) Pub. Date: Mar. 10, 2011

(54) System and method for structuring, trading, and processing differential funds

(76) Inventor: Andrew Kennon Jennings, Hillsville, VA (US)

(21) Appl. No.: 12/878,105

(22) Filed: Sep. 9, 2010

Related U.S. Application Data
(60) Provisional application No. 61/240,984, filed on Sep. 9, 2009.

(51) Int. Cl. G06Q 40/00

(52) U.S. Cl. 705/37

(57) ABSTRACT

A system and method is provided for structuring, and recording and processing information and data flow necessary to effect trades; creations; and redemptions of shares of, a differential fund. A differential fund comprises an underlying index or basket of securities, commodities, or other assets, with share classes equivalent to the number of and linked to components or sectors of the underlying. The system and method allocates dividends, distributions, or capital appreciation owing each class by weighting a predetermined financial indicator of each component to each other and then applying distributions or appreciation owed to the whole fund to individual classes based on the indicator weighting. Shares trade freely at a market premium over the net-asset value or market price of the fund. Because each share is backed by the entire underlying, the net-asset value or market price of the underlying establishes a natural lower-bound in the price of a share.

### BACKGROUND OF THE INVENTION

The present invention is in the technical field of structuring and administering trades, creations, and redemptions of securities. More particularly, the present invention is in the technical field of structuring and administering trades, creations, and redemptions of a novel form of exchange-traded fund.

In recent years exchange-traded funds (ETFs) have grown in popularity among investors. These funds are typically described as a hybrid between mutual funds and publicly traded securities, commodities, or other investable assets. In an ETF, assets are pooled in a trust according to the list of components and weightings of an index, index sector or sub-sector, some other identifiable array of securities or commodities, or at advisor discretion or criteria in actively managed portfolios. Shares of such ETFs trade on public exchanges. If one owns a sufficient number of such shares (“creation unit”), typically 50,000, he or she may redeem them with the trust and receive the underlying shares in-kind. Similarly, if one owns the actual assets underlying an ETF in appropriate proportion, these may be submitted to the trust in exchange for shares therein.

The recognized benefits of ETFs include cost-effective diversification, intra-day pricing, the ability to use hedging strategies, including put and call options, and smaller discount/premium spreads from net-asset value and management fees vis-a-vis traditional mutual funds. Several methods in the prior art provide for reducing downside risk in ETFs. These methods are similar to those available for individual securities and include protective puts and equity collar transactions. Negative aspects of the existing downside protection art include transaction costs and fees, conceptual complexity requiring sophisticated knowledge to use effectively, and the eventual expiration of protective features. A more general limitation of the prior ETF art, particularly pronounced in index or sector funds, is that investors, in order to participate in index- or sector-wide trends, forgo the relative gains of high-performing components vis-a-vis the index or sector to the extent that they use ETFs. The differential fund is envisioned as a solution to this limitation, wherein investors continue to participate in broad indexes or sectors, enjoy the downside protection of being invested in an index or sector underlying, and also enjoy potential upside potential for assets that outperform their index, sector, or other benchmark.

### BRIEF SUMMARY OF THE INVENTION

The invention relates to a computing and manual system and method for structuring, trading and processing differential funds. Differential funds are publicly traded funds that allow investors to participate in the diversification and appreciation available to an index, sector, or other class of underlying assets, while also participating in enhanced potential appreciation and distributions from individual components or sectors of components of the underlying.

Embodiments of the invention improve upon the existing art by providing upside participation and downside protection as compared to investing in shares of ETFs or individual securities. Investors derive new benefit from combining the diversification qualities of an ETF with the higher appreciative potential of securities and commodities that investors expect to outperform the index or sector of which they are a component. Given that each share is backed by the entire underlying, capital losses on any share of the fund are limited to a lower-bound, i.e. the net-asset value or market price of the fund underlying. Moreover, investors benefit from a novel way to receive dividend or other income from shares of superior performing companies that retain all or a substantial part of earnings. In addition, the present invention lowers transaction costs and counter-party uncertainty associated with other downside protective methods, including protective puts and equity collar transactions, and, in contrast with options-based protective strategies, its protective feature has no expiration.

Finally, embodiments of the invention offer greater conceptual and transactional simplicity than existing art, allowing investors better to make and understand investment decisions and customize investment strategies.

### BRIEF DESCRIPTION OF THE SEVERAL VIEWS OF THE DRAWING

FIG. 1. is a block diagram representation of an embodiment of a differential fund holding shares in three individual equities and offering share classes linked to each individual company component and one linked to a sector consisting of two of the individual components.

FIG. 2. is a block diagram representation of the computing, institutional and manual system for creating, redeeming, and trading shares of a fund, particularly how the invention interacts with the institutional and manual components of the system.

FIG. 3. is a numerical representation of processing means and the financial indicator weighting process of the present invention.

FIG. 4. is an embodiment of the invention wherein shares of a component are “stacked” in a share class in order to cause the linked component to have an out-weighted effect on the performance of the class.

### DETAILED DESCRIPTION OF THE INVENTION

A differential fund is a form of and improvement on exchange-traded funds. It comprises an underlying index or basket of securities, commodities, or other investable assets, with share classes equivalent to the number of and linked to components or sectors of the underlying. The computing and manual system and method allocates dividends, distributions, or appreciation to each class by weighting some financial indicator of each component to each other and then applying dividends, distributions, or appreciation owed to the whole fund to individual classes based on the indicator weighting. Examples of possible indicators include share price and capitalization. Shares trade freely at a market premium over the net-asset value or market price of the fund. Premiums from new creations are used to re-weight the holdings of components in the fund. Since creation units of a differential fund may be redeemed for their underlying, the net-asset value or market price of the underlying establishes a natural lower-bound in the price of a share.

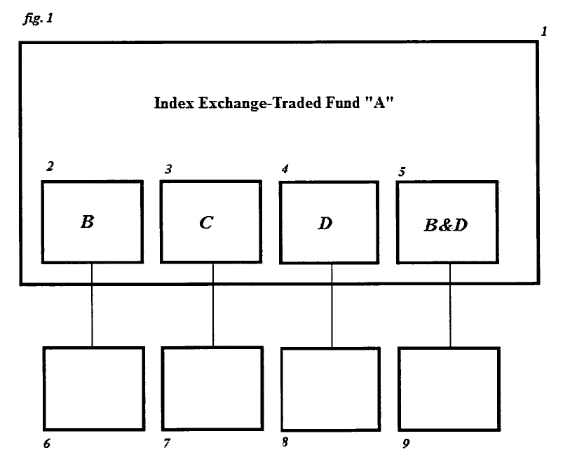

An embodiment of the invention is provided for structuring a differential fund and for managing it by processing and recording information and data flow necessary to effect trades, creations, and redemptions of shares of the fund. Such a system and method is used once a fund sponsor has established a differential fund. FIG. 1. depicts an embodiment of differential exchange-traded fund's holding trust 1 comprising equity components B 2, C 3, and D 4. Additionally, and optionally, the fund offers a share class 5 linked to a sector consisting of components B and D. Within the figure thin lines indicate shareholding relationships; these shares are owned by shareholders represented by 6, 7, 8, and 9, who may be, for example, individuals, mutual and investment funds, authorized fund participants, broker-dealers, institutional investors, funds, or other investors.

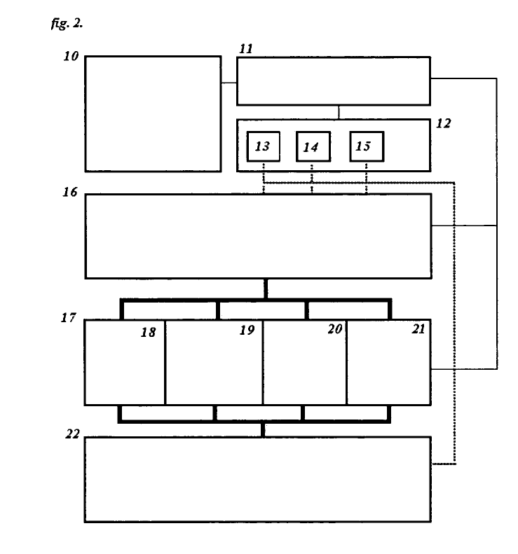

FIG. 2. depicts the broader computing, institutional, and manual trading system universe typically used to trade publicly-traded securities and commodities. Within the figure thin solid lines represent input and output regarding the functions of the present invention 11. Dotted lines indicate shareholding relationships. Bold solid line indicate public or private trading activity. Fund sponsor 10 interfaces with its fund's 12 authorized participants 16 through a computerized and manual trading system embodiment of the invention 11. Authorized participants offer their creation unit shares on a plurality of public and private trading systems 17 including, for example, alternative trading systems 18, electronic communication networks 19, over-the-counter trading facilities 20, and public exchanges 21 to non-authorized participant investors 22 such as 6, 7, 8, and 9. In like manner the authorized participants purchase creation units from the open market to redeem with the sponsor. This embodiment interfaces with the trading systems described to continuously update trading, volume, premium, pricing, and other data so as to inform the fund sponsor and authorized participants of the data for automated and human-based decision-making.

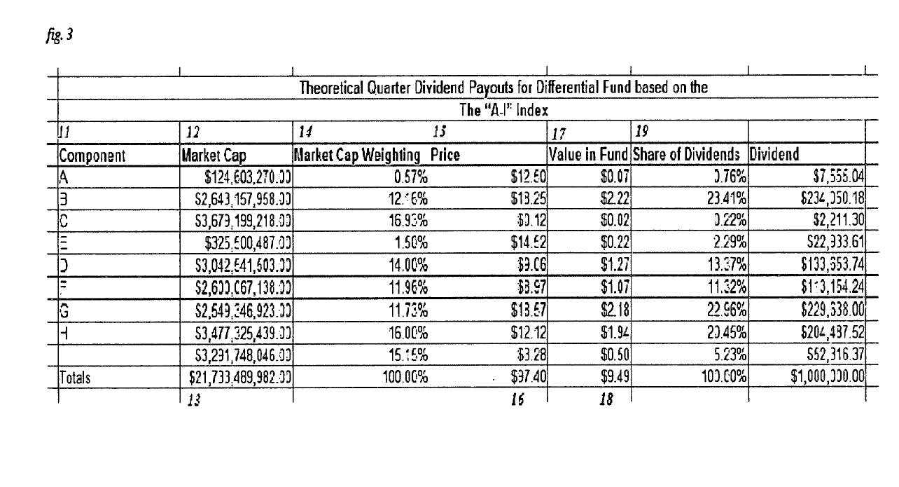

FIG. 3. is a numerical representation of the quarterly dividend payout for a differential fund based on the hypothetical “A-I” Index. The index comprises a plurality of components 11 each of which has a unique market capitalization 12 and each of which is linked to a class of shares of the fund. Without regard to the total monetary value of the holdings of the fund, the market capitalization of the index 13 is the sum of the capitalizations of each component of the index. The “A-I” Index is weighted according to market capitalization, though another financial indicator may be used. Therefore, the proportion of each component of the index in the index is determined by dividing the market capitalization of each component by the market capitalization of the entire index, producing the index weightings 14. The market prices 15 of each component of the fund sum to an unweighted price to acquire a share of each component of the fund 16. When the market share prices of each component are multiplied by their market capitalization weightings in the fund, the value of each component in the fund 17 is found. The values of each component in the fund sum to the price of the fund 18. In this embodiment, the total dividends or distributions available to shares of the fund after a quarter sum to $1,000,000 19, the financial indicator used to weight dividends and distributions is average quarterly price, and the average quarterly prices of each component and the fund are assumed to be the instant prices 17 and 18. Therefore, dividing each component's value in the fund by price of the fund results in the proportion of dividends or distributions 19 owing to each class of the fund. In this figure, share class “B” receives approximately 234% of the mean dividend, while share class “A” receives only approximately 7.6%.

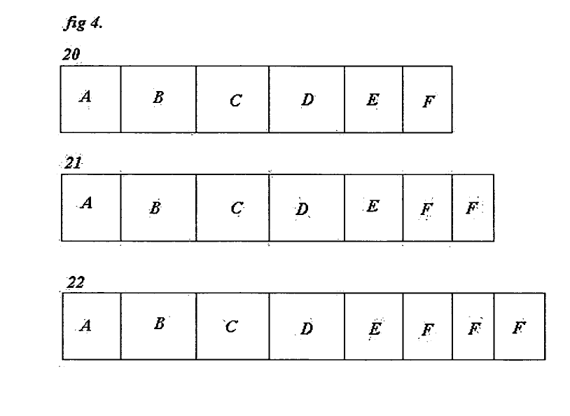

FIG. 4. depicts an embodiment of a “stacking” differential fund. An index 20 weights all components equally, and is presented with components A, B, C, D, E, and F. A “stacked” DETF 21 is presented with identical components, but includes an additional unit of component F. The effect of this “stacking” is that the performance of the DETF shares will deviate, up or down, from the performance of the underlying index on the basis of F's performance. DETF 22 is similar to the proceeding fund, but adds even more units of F. Although the funds in this figure hold all units long, nothing prevents a “stacked” differential fund from having one or more short units.

The advantages of the present invention and its associated differential fund include, without limitation, a novel hybrid between investing in exchange-traded fund shares and individual securities or commodities, upside participation for components that outperform their index or sector, downside protection from declines in the value of individual securities or commodities, lower transaction costs vis-a-vis existing downside protection strategies, and transactional and conceptual simplicity.

### CONCLUSIONS, RAMIFICATIONS, AND SCOPE

The invention is an improvement on exchange-traded funds. While it is not intended to replace the prior art completely, it does provide a superior alternative to consumers under certain circumstances. Among these circumstances are investment objectives which seek higher upside potential vis-a-vis an index or sector ETF, or to limit downside risk vis-a-vis investing in single equities, commodities, and other classes of assets. The invention provides a built-in hedge for the investment position a consumer takes, and does so in a conceptually and administratively simpler manner than existing hedging art.

While the foregoing written description of the invention enables one of ordinary skill to make and use what is considered presently to be the best mode thereof, those of ordinary skill will understand and appreciate the existence of variations, combinations, and equivalents of the embodiments, methods, and examples herein. The invention should therefore not be limited

What is claimed is:

1. A system and method for creating a differential fund, wherein a fund comprises an underlying index or basket of securities, commodities, or other assets and issues a number of share classes equivalent to the number of components, which may be a sector or other configuration of discrete components, of the underlying and which components are each linked to a separate share class, and where the average market price, capitalization, or other predetermined financial indicator over a period of time of each fund component or sector is weighted and compared to every other component or sector and wherein the pooled distributions or appreciation owing to the fund is allocated to share classes according to their linked component or sector's weighted relative indicator.

2. The weighting system of claim 1, wherein the distributions, dividends, capital appreciation, or re-investment owing to the whole fund's underlying is weighted proportionally or otherwise between share classes and then applied thereto based upon the weighted predetermined financial indicator described in claim 1.

3. The shares described in claim 1, wherein such shares may be freely traded on exchanges, over-the-counter, communication networks, or through other trading means.

4. A system and method for redeeming shares described in claim 1 such that creation units or individual shares of a share class are redeemed by the fund issuer for the net-asset or other value of the fund underlying.

5. The system and method described in claim 1, wherein new issues of shares carry a premium over the market or net-asset value of the underlying and wherein said premiums are applied to re-weight the holdings of individual components or sectors within the underlying.

6. The system and method for creating a stacked differential fund, wherein one or more additional units, long or short, of an index or sector component is added to the underlying of a class, thus out-weighting the effect of that component on the performance of the class.

7. A computing system for recording and processing information and data flow for trades, original issues, and redemptions of shares of differential funds described in claims 1 through 6, comprising:
(a) computer processor means for processing data;
(b) storage means for storing data;
(c) first means for initializing computer processor;
(d) second means for initializing computer processor by electronic communication network, exchange, electronic system for enabling manual trades, or other trading system;
(e) third means for initializing storage medium;
(f) fourth means for initializing storage medium by trading system;
(g) fifth means for processing and storing data regarding the composition of a fund, the holdings in each of a fund's components, which may be a sector or other configuration of discrete components, and assignments of a share class linked to each component of a fund's underlying;
(h) sixth means for processing and storing data regarding each share class of a fund, price and other financial indicators, trades, creations, redemptions, settlements, and shares outstanding of each;
(i) seventh means for processing and storing data regarding the average market price or other financial indicator of a component of the underlying and weighting the same relative to each other component of the underlying;
(j) eighth means for processing and storing a distribution allocation ratio applicable to each share class based on data processed and stored from seventh means;
(k) ninth means for processing and storing dividends, distributions, or appreciation owing to a fund, and thence allocating distributions to individual shares according to the allocation ratio;
(l) tenth means for processing and storing records of pricing data for net-asset value or market price of the underlying, and thence processing and storing records of the price of a share class over the price of the fund;
(m) eleventh means for processing and storing records regarding redemptions of shares for the price of the fund; and
(n) twelfth means for processing and storing records of premiums of new share issues, and thence processing and storing records of the optimal use of premiums from new issues to re-weight and balance component holdings in the underlying.
